(19) United States
(12) Patent Application Publication
(10) Pub. No.: US 2002/0019849 A1
(43) Pub. Date: Feb. 14, 2002

(54) Information communication system

(76) Inventors: Eldar Tuvey, London (GB); Roy Tuvey, London (GB); John Edwards, London (GB)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/904,846

(22) Filed: Jul. 16, 2001

(30) Foreign Application Priority Data
Jul. 14, 2000 (GB) 0017380.7

(51) Int. Cl. G06F 15/16

(52) U.S. Cl. 709/206; 709/202

(57) ABSTRACT

A method and system for embedding additional information into an electronic communication transmitted via a network from a sending party to a receiving party. An electronic communication processing engine loadable onto a computer intercepts the electronic communication. Information about the communication is extracted and sent to a remote server. The remote server replies with instructions for embedding the additional information and the content of that information. The communication is then modified based on this reply from the remote server, to embed the additional information in it, and subsequently transmitted on to the receiving party.

### FIELD OF THE INVENTION

The present invention relates to an information communication system. The invention particularly relates to a system for use with electronic mail applications. One specific field of application is for the dissemination of advertising material with electronic mail communications, but the invention is equally applicable to the dissemination of material of any other nature.

### BACKGROUND

With the advent of the Internet, and more particularly electronic mail, usually termed email, new avenues of communications have been opened. It is estimated that 85% of Internet users use email to communicate with friends and family. Furthermore, it is also estimated that 30% of online time is devoted to writing, sending and reading emails.

Electronic mail is also now very widely used for business communication, both company to company and between the employees of any particular company.

Despite the vast volume of such electronic communication, the nature of the communications is that they tend to be thought of only as a way of delivering a specific message from an individual to one or more specific individuals. This avenue of communication has, however, been largely ignored as a channel for third party information providers (i.e. parties who are neither the sender or recipient of the communication) to distribute additional information.

Taking advertising as an example, the benefits of doing this are clear. In particular, the positive effect of advertising upon a company's sales is well documented. Greater advertising and product exposure will usually result in greater sales, and consequently greater profits. Therefore, organisations are anxious to promote their products through all available mediums in order to achieve maximum exposure. The medium of emails is not yet exploited effectively.

It is useful here to consider the background to the basic mechanisms by which emails (or other electronic communications) are transmitted. A network is a group of computer systems linked together. The Internet is a global network connecting millions of computers. Computers and devices that allocate resources for a network are called servers. For example, a network server is a computer that manages network traffic, and a database server is a computer system that processes database queries.

A Servers are generally dedicated. This means that the computer performs no other task besides their server duties. However, on multi processing operating systems a single computer can execute several programs at once. In this instance a server could refer to the program that is managing the resource rather that the whole computer. It is also usual to refer to the company providing the resource management as the server. Thus references to ‘server side’ correspond to actions or programs that occur at the location of the server.

The Internet, of which email is part, uses protocols to define how data is formatted and transmitted across the Internet. It comprises a system of servers that support specifically formatted documents. These Internet servers are usually termed the world wide web (WWW). The formatting language of the documents that support the WWW is termed Hypertext Markup Language (HTML) This language supports links to other documents, allowing a user to skip from one page to the next. This is generally achieved by “clicking” specified on screen icons using a mouse or other tool.

Conventionally the WWW uses Hypertext Transfer Protocol (HTTP) as its base protocol. Hence it is HTTP that defines how data messages are formatted and transmitted. Also it is HTTP that governs what actions web servers or browsers should take in response to commands given. An example is when a URL is entered into a web browser. In this action a HTTP command is sent to the web server directing the server to retrieve and transmit the requested web page.

Email uses different protocols from the WWw. The most popular of these include SMTP, POP and TMAP.

SMTP, Simple Mail Transfer Protocol, is a protocol for sending electronic messages, or email, between different servers. The majority of email systems that send data over the Internet use the SMTP protocol to relay messages from one server to another. Additionally, it is usual for messages to be sent from email applications to email servers via SMTP.

Post Office Protocol (POP) is a protocol substantially used for retrieving email messages from a mail server. For many years, the original version of POP, POP2 was the industry standard and required SMTP to send messages. However, the latest version, POP3 can be used independently, or in cooperation with SMTP.

IMAP, or Internet Message Access Protocol is a protocol with similar features to POP3.

A user generally logs onto the Internet using a modem which is controlled by a software package. The access will be achieved by using a telephone number provided by an Internet Service Provider (ISP). Once ‘on’ the Internet a user may send and receive email. In the case of an organisation in which there are multiple user's or an email system, it is often the case that the organisation operates an email server which handles the delivery of internal communications between users within the organisation. The organisation's mail server will typically also serve as a central point from which emails from individuals within the organisation are sent via the Internet to recipients outside the organisation and to which emails from outside the organisation are received and distributed to the intended recipient within the organisation.

The vast majority of ISPs support portals, termed Network Access Points, which allow users of differing ISP systems to exchange email with one another.

Thus, when a user wishes to send email, he will input messages into his computer using appropriate software and the system will then be instructed to send the message to the desired recipient. This action may prompt an opening of a phone line connection to the sender's ISP. Alternatively, the user may already be connected to the ISP at the time that the message is composed (e.g. directly or via their organisation's email server). The data corresponding to the message is received by the ISP (possibly via an organisation's mail server) and sent out across the Internet. The message is transmitted to the ISP of the recipient by using the routing table that comprises the Internet. The recipient may then receive their message from their ISP (again possibly via their organisation's mail server).

In addition to sending email in the manner described above, it is possible to send email through a system that is conventionally termed webmail. Webmail allows users with web browsers to send email without an email account. An example of this system is Hotmail. Webmail is based on open web-based technology. A web browser is used for emails sent and received by the governing server, i.e. the server of the operator of the system, often a website, which hosts the webmail.

As email has become one of the world's biggest mediums for communication, advertisers and other provider's of information would like to take advantage of this medium to reach a large number of consumers. Further since emails are generally directed to a particular person or group of people, there is a potential to direct information, including for example advertising, more specifically than has been possible previously.

### SUMMARY OF THE INVENTION

The present invention seeks to provide methods and systems by which information can be added to an outgoing or incoming electronic communication, e.g. email.

According to a first aspect of the present invention there is provided a method of embedding additional information into an electronic communication transmitted via a network from a sending party to a receiving party comprising the steps of:

(i) intercepting the electronic network communication sent by the sending party addressed to the receiving party;

(ii) extracting and sending information relating to the network communication to a remote server;

(iii) modifying the network communication to embed the additional information in the network communication according to instructions and information provided by the remote server in response to the information sent to the remote server; and

(iv) transmitting the modified network communication to the receiving party.

The invention also provides a system, which preferably operates in accordance with the above method, the system comprising an electronic communication processing engine loadable onto a computer wherein the electronic communication processing engine is capable of intercepting an electronic communication sent over a network from a sending party to a receiving party, sending information about the communication to a remote server and modifying the communication based on a reply from the remote server to embed additional information in it.

The electronic communication processing engine may operate, for instance, as a mail processing engine by forming part of the transmission path for the communication and filtering the POP, SMTP and/or HTTP data passing through it in the case of conventional email protocols.

Preferably, the mail processing engine is capable of running on a variety of different operating platforms. For this reason, in preferred forms the mail processing engine is implemented in the Java programming language.

Considering both the method and system of the invention, the network may be the Internet or an organisations internal intranet for instance. The sending and receiving parties will typically be email clients or other communication applications resident on personal computers (e.g. desktop computers, laptop computers or palm computers), but one or more of them may also be applications resident on other types of device such as a mobile telephone, television or the like.

The additional information may take any form, including textual and graphical content, links to other information, audio and/or visual content.

The remote server may be running on a physically remote computer or may be running on the same physical machine on which the communications are intercepted. The remote server preferably generates the instructions and information for modifying the communication by employing an algorithm running on the remote server that combines the information extracted from the communication with one or more rules, other information, historical data or a combination of these.

The method and system may operate to intercept and modify the communication at any point along the network path via which it is transmitted from the sending party to the receiving party. For example, the interception may take place:

(a) at a client computer (PC or other), or other client device on which the sending party or receiving party resides;

(b) at an organisation's mail server (e.g. a mail server serving a department, office or complete corporate entity on the sender's or receiver's side or a proxy of such a server);

(c) at an orgarnisation's mail gateway (e.g. a corporate mail gateway);

(d) at an ISP's server or proxy server;

(e) at any SMTP mail relay in the transmission path; or

(f) at any other location in the transmission path that is able to host a network proxy application.

The rules applied by the algorithm that generate the instructions and information provided by the server to embed the additional information will be defined for the particular application to which the method is put to identify the appropriate form or content of the additional information. In any particular application of the method, the rules may be generic, in the sense that they are applied to all communications. Alternatively, rules may be made specific to individual senders and/or recipients or groups of senders and/or recipients. Where the rules are applied to groups, the members of the groups may be defined by reference to a specific list of individuals or by some common attribute.

There are various situations in which such a method and system may be advantageously adopted. By way of example, the method may be employed to;

(a) Embed advertising material into emails; or to

(b) Add reference information to emails—for example an organisation's mail server may be controlled to add information to incoming mails about the sender of the received email where this information was available from a resource to which the organisation has access, or alternatively information about a sender's particular area of expertise or information specifically targeted at the recipient or the organisation they work for may be added to an organisation's outgoing emails.

Many other exemplary uses will be apparent to the skilled person.

At whatever point in the passage of the communication from sender to receiver the modification takes place, it is generally preferred that the additional information is embedded in the communication is its final form, that is the form it is intended be viewed at the receiver party. In this way, the communication including the additional information can be viewed ‘off line’.

The present invention is particularly useful where the communication is an email.

The method and system of the present invention is preferably capable of allowing interaction with both webmail and ISP based mail. Often a user may have two email accounts, one web based, such as Hotmail and the other provided by an ISP. The present system is preferably capable of interacting with mail from both systems. Alternatively, if a user only has one such account the present invention is preferably capable of interacting with either system in isolation.

It is of course possible within the scope of the invention set out above that a user's device (e.g. PC or the like) serves as both sending party and receiving party for successive emails, such that both incoming and outgoing emails to and from the user are modified.

It may be desirable to store information associated with the intercepted emails to be used, for example, in the determination of the content of the additional information to be embedded in subsequent messages to, from or between the same parties. Conveniently, therefore, provision may be made for interaction with an e.g. server side database to store this information. The database server may be integral with the remote server. Alternatively, there may be a plurality of databases on different physical servers. In this arrangement, a second database may replicate a first database to provide a back-up to give a more resilient system.

The information stored in the database (or databases) may include, but is not necessarily limited to, historical data such as:

(a) details of communications sent, including for instance dates, times, software used to send, software used to transmit, network addresses of recipients and senders, etc;

(b) details of communications that have been read, including for instance date and time read, software used to read, etc;

(c) details of hyperlinks contained within mails that have been clicked, including time and date of click-through, software used, click destinations, clickstream activity following initial click, etc; and

(d) details for mails which the sent or received mail is in reply to.

In a particularly preferred embodiment of the invention, particularly where it is desired or necessary for the database to maintain the anonymity of the recipient and/or sender while still permitting subsequent re-identification of communications from the said anonymized parties, the invention uses a collision resistant one way hash function (or equivalent) to anonymise the local component of the email address (that part lying before the @ symbol) prior to storage. This mechanism ensures that the local part of the address may not be determined by examining that data in the database, however subsequent re-identification is made possible by processing the local part of the address with the same function prior to performing the database lookup. The same mechanism may also be applied to the domain part of email addresses, the whole email address, or any other identifying component of the communication requiring anonymisation. In preferred forms of the invention, the collision resistant one way hash algorithm used is the MD5 Message Digest Algorithm (RFC 1321). In an alternative embodiment, a keyed collision resistant one way hash function (e.g. MD5-MAC) may be employed to guard against subsequent reidentification by any third party not in possession of the key.

This data can be aggregated for easy retrieval and analysis for example by using data such as sender, recipient, sender domain, recipient domain, time, time of day, date etc as keys.

Other data stored may also include user preference data associated with individual senders or recipients or groups of these individuals defined e.g. by domain.

This data and other similar data can then be used by the system to optimise the additional information that is added to future communications.

In a particularly preferred embodiment of the invention, this stored information is used to determine the mail format capabilities of a recipient (i.e. the receiver party to which a communication is addressed), for instance whether the recipient's mail client is capable of processing HTML code, flash data or Java applets. The additional information to be embedded can then be tailored in accordance with the capabilities of the receiver party to be compatible therewith.

One form of this server side database might be a centralised address book for example. When a network communication is intercepted the contact details of the recipient or sender being gathered automatically and stored on the database under an identification of the user. The particular user's preferences and the capabilities of their mail application could then be associated with their address book entry.

The interaction between the computers and the servers and/or with the databases is preferably achieved via HTTP. The interactions between the servers and the database is preferably achieved via JDBC. This allows the application to seek instruction from the server side database regarding the nature of the information to be embedded into the communication.

In some embodiments of the invention it is preferred that the interception of the communications can be controlled remotely. For instance, the mail processing engine need not be a hardcoded agent, but rather can be a slave that is manipulated from a remote server. The mail processing engine may be constructed with operations that may be executed in a plurality of combinations by the server to detect and modify a plurality of network communications. The mail processing engine is preferably constructed with capacity to receive automatic updates from the remote server.

Individual functional components of the mail processing engine can be distributed about the network and can be located either on a client or server side device.

In a preferred embodiment of the present invention the inserted information embedded into the communication may be read off line. Preferably the present invention conforms to the MHTML email standard (RFC 2557).

As already noted above, the content of the additional information may take any form, including for example text graphics, audio and/or visual content, or links to such content. This content may be added to the communication (typically email) in two alternative ways.

Late Sound referencing is a method in which the information to be displayed to the recipient is not itself included in the communication at the time the communication is modified. Instead, the communication is modified by the insertion of a reference to the content it is intended be displayed within the message. When the recipient opens the communication to read it, the receiving party mail application must resolve and retrieve the reference to display the desired content.

Alternatively a method of Early Bound referencing can be employed. In this method the additional information is embedded into the communication in the form it is intended to be viewed at the time of its modification by the mail processing engine. The receiving party mail application is then able to display the image or information immediately on receipt without the need to retrieve additional content from elsewhere.

The main advantage of late bound approach is that the content of the additional information (e.g. advertisement) can be chosen at the time the communication is read and tracked very accurately. The disadvantage is that it requires the user to be online (or otherwise have access to the referenced content) when reading their mail—users who are not online either receive a “broken image”, or are prompted to dial-up every time they read a mail. Additionally, maintaining the same advert (or other information) in a mail for a long period (i.e. weeks) is problematic. Early bound adverts allow the recipient to view adverts (or other additional information) offline and do not increase their net download time. The disadvantage is that the content of the additional information must be chosen and tracked at send time rather than read time.

In a preferred form, the present invention comprises a system that supports both approaches intelligently. Mails destined for webmail only services (i.e. No POP facility) are late bound, whilst all other mails are early bound.

In a preferred embodiment of the present invention the invention is adapted to observe ISP details from a range of third party email applications. Thus, through the present invention it is possible to remotely detect which ISP, is hosting the user.

Preferably the present invention is capable of multi-playout of emails. This comprises transparently converting single mails with multiple recipients into multiple mails with single recipients. This allows different rule sets and processing to be applied to each recipient. Thus an email sent to ten is individuals is, in effect, broken down into ten separate emails. This then allows different algorithms, rules, historical and other data to be used in processing each mail and for different information to be inserted into each mail.

In some embodiments, the users of the system are given the opportunity to influence the content of the additional information added to their communications. For example, the type or content of the information embedded into the communication may be chosen directly by the recipient or sender of the communication. Alternatively, the users may provide the system with preferences, the nature and content of the additional information being influenced by these sender and/or recipient preferences. For instance, the embedded information may be determined algorithmically as a function of the preferences in combination with other data including, for example, historical data relating to previous communications from, to or between the sender and recipient. In this way, the preferences supplied by the users of the system are used to choose the information to be embedded into the communication from the available content pool.

It is also preferred that the (e.g. Java) mail processing engine is designed to degrade gracefully, preferably during periods of infrastructure failure. More specifically, the mail processing engine is preferably designed to revert to pass through (i.e. simply passing communications on to the intended recipient without any modification) whenever any problems are detected.

Preferably communication from the web server to the web browser is encrypted. This is preferably achieved using SSL.

Whilst any web server may be used an Apache web server is particularly preferred.

Particularly where the emails of individuals (as opposed to those originating from within an organisation) are to be modified, it may be advantageous to provide a locally installed miniature web server, allowing the user to view a website offline. Preferably changes of the website are synchronised automatically when the user goes online

It is preferred that the miniature web server is able to accept standard HTTP requests from a web browser and, preferably, generate corresponding standard HTTP responses. It is preferred that the miniature web server works in conjunction with the downloadable software. Ideally the software redirects requests to the miniature web server if the user is offline. Preferably the redirected requests include requests for inclusion of information, such as an advertisement, and requests from users to alter the type of information that is to be inserted into the communications.

If a request for an advert (or other information) is sent when the user is offline, the miniature web server collects the information to be inserted and relays it to the server once the user returns online.

Also, where the system is to be used by individuals (as opposed to members of an organisation) it is preferred that users wishing to have the application (i.e. the electronic communication processing engine) loaded on to their computer must register with a central administration system. Preferably there is a web based interface for the user to the internet, which is preferably for registration and account management. In a preferred embodiment of the present invention the web interface comprises a combination of Java servlets and Java server pages. The interface is preferably run within the Jrun servlet engine.

### BRIEF DESCRIPTION OF THE DRAWINGS

In order that the present invention be more readily understood specific embodiments thereof will now be described with reference to the accompanying drawings in which:

FIG. 1 is a diagrammatic overview of the known interactions for sending and receiving electronic mail;

FIG. 2 is a diagrammatic overview of an advertising system in accordance with an embodiment of the present invention in which the mail processing engine is resident on a user's PC;

FIG. 3 is a diagrammatic overview of other systems in accordance with embodiments of the invention, demonstrating the choice in the location at which the mail processing engine is installed; and

FIG. 4 is a more detailed schematic of the technical architecture of one embodiment of the present invention in which the mail processing engine that intercepts and modifies email communications is installed on a user's PC.

### DESCRIPTION OF EMBODIMENTS

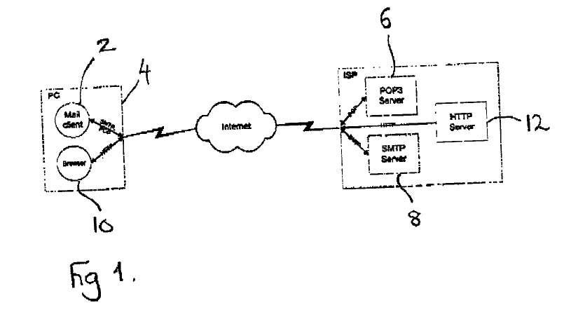

Referring to FIG. 1, in a conventional system for sending and receiving email over the Internet, a mail client 2 installed on a user's PC 4 sends and receives POP or SMTP messages to and from corresponding POP or SMTP servers 6,8, at their ISP (internet service provider). Alternatively, they may use a browser 10 installed on their PC 4 to access a webmail server 12 via their ISP.

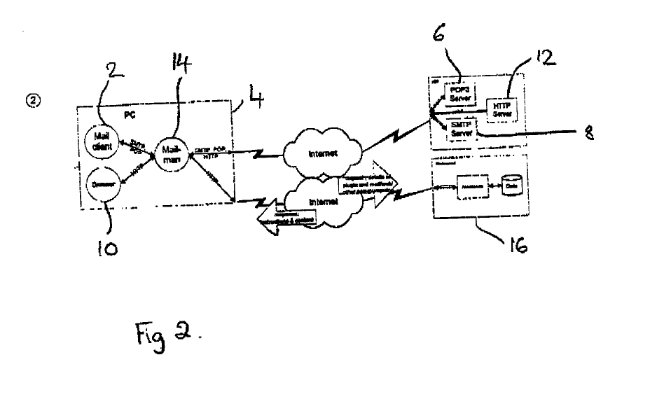

FIG. 2 shows, in a schematic manner, how this conventional configuration is modified in accordance with an embodiment of the invention. The same reference numerals are used for the same components that appear in FIG. 1. As can be seen, an additional application 14 is installed, in this example, on the user's PC. It serves as a mail processing engine (termed “mailman”), which sits in the path of email messages sent from or to the user's email client 2 or downloaded to their browser 10.

The mailman 14 intercepts the messages, extracts information from them (e.g. the sender's and recipient's email addresses) and sends this extracted information to a remote, server 16, running on a physically remote computer, via the internet. The server 16 processes the extracted information to determine the appropriate form and content of additional information (e.g. an advertisement) to be embedded in the email. Instructions for embedding the additional information and the content itself or a pointer to it are returned to the mailman 14 which inserts the information into the email and passes the modified message onto the recipient.

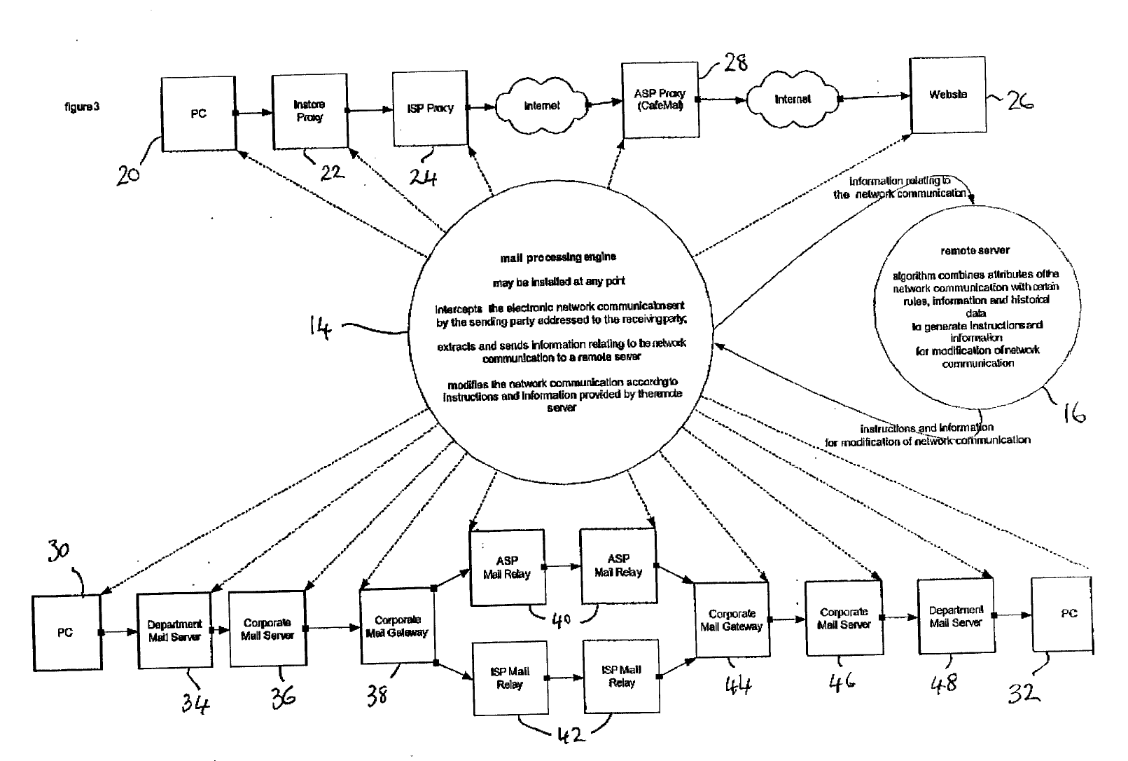

A single remote server 16 may, and usually will, provide instructions and content to multiple instances of the mailman application installed on different user's PCs or elsewhere in email transmission paths, as is illustrated in FIG. 3.

FIG. 3 illustrates the manner in which the mailman, or mail processing engine 14 and its associated remote server 16 can be conveniently used on two other environments. The top of FIG. 3 illustrates a typical configuration of the communication architecture used in an internet café environment. One or more PC's 20, which are made available to customers of the internat café, are connected to an instore proxy 22, which in turn has a permanent communication link to an ISP proxy 24. The customer's of the café access the Internet via this communication network to access websites 26, including those of webmail servers to retrieve or view their emails.

As indicated in the figure by the dashed arrows, the mail processing engine application can be installed on any of the physical devices in the network communication path at which it can intercept messages. For instance, it may be installed on each individual PC 20 in the café or, more preferably, on the instore proxy 22. It is also possible to host the mail processing engine off-site on a dedicated ASP proxy 28. Typically in an internet café environment global rules will be used to determine the form and content of additional information embedded in the email communications.

At the bottom of FIG. 3, a typical organisation's (in this case corporate organisation) email system is illustrated. Mail is sent from an PC 30 within a first corporate entity to the PC 32 of a recipient in another corporate entity. The mail is routed via a departmental mail server 34, corporate mail server 36, and corporate mail gateway 38 in the sender's corporate entity, then via one or more. ASP or ISP mail relays 40, 42 to the corporate mail gateway 44 of the recipient's corporate entity, from where it is routed to the intended recipient's PC 32 by corporate and departmental mail servers 46, 48.

Again, as in the internet café example, the mail processing engine can be located on any one of the physical devices in the path through which the message is routed from sender 30 to recipient 32.

Whilst the additional material embedded in emails in the corporate environment may well be advertisements or other corporate branding material, other possibilities are opened up by the system described. For instance, emails may be personalised based on the identity of the sender, recipient and/or their respective organisations. The content or form of the embedded information may also be influenced by the history of previous communications between the parties (individual or corporate). By way of example, the sender of an incoming email may be looked up in a corporate database of the recipient's corporate entity and specific information about that person be added to the email they have sent. Useful information such as their full name, street address, telephone an fax numbers could be included in this way, or a link to their website for example. It may also be possible to include references to pending actions or enquiries with that person or their organisation or to include other historical information about the relationship between the parties.

Particularly where information of a personal or confidential nature is included in the additional information embedded in the email, it may be desirable to configure the mail processing engine to remove the additional information, perhaps replacing it with alternative information, if the email is re-transmitted to the originator of the message or to any other person not in the recipient's organisation.

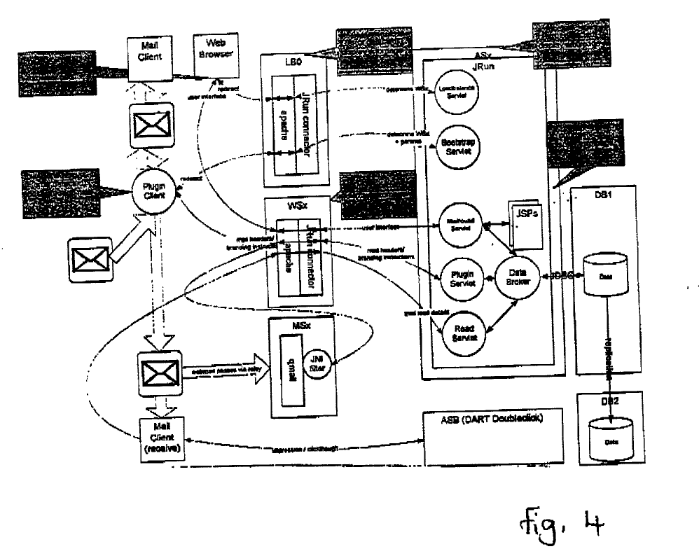

The manner in which the mail processing engine or “mailman” interacts with the communications it intercepts and the remote server, will be better understood by reference to FIG. 4 and the more detailed description of the operation of a specific example that follows. It is described in the context of the configuration illustrated in FIG. 2, but the principles on which it is based are applicable also to the use of the system in other environments, such as the internet café and corporate environments described above.

Referring to FIGS. 2 and 4, the mailman is a Java based application (labelled “Plugin client” in FIG. 4) installed on the user's computer. The program is constructed and designed to make use of existing Java virtual machines where possible, to minimise the download size of the program. Java virtual machines comprise Java interpreters and Java runtime environments. Compiled Java code can be run on most computers because Java virtual machines exist for most operating systems.

The Java application runs on the user's computer and inserts or embeds inbound and out bound emails according to instructions from applications running server side on web servers.

The application is able to insert the information into the email as it is capable of intercepting local network communications (such as email). However, if required the application can remain transparent to such communications.

When in use the application requests, receives and acts on instructions from a remote server, termed a web server. As the application receives data string corresponding to an email message it parses the data and relays it onto the mail server. The web server receives the message components from the application and parses the message components according to general rules, as well as specific rules relating to a specific application program. The modifying instructions are then sent back to the application, which modifies the email message in accordance with the instructions.

The web server and application are also in contact regarding the configuration of the message. The application sends requests to the server, which in turn processes said requests and sends configuration updates back to the application. The application, in response to the instructions updates the configuration of the email.

The user's computer creates an interface between the user and the Internet. This interface is created using a combination of Java servlets and Java server pages on the Server. The interface is run within a JRun servlet engine in an application server and integrated development environment for constructing and displaying server side Java applications.

The data communication between the server and the browser is encrypted using SSL, to protect information such as passwords and account balances. SSL stands for secure sockets layer and is an application that pipes encrypted information over the Internet using public key cryptography.

The Java based application intercepts email from the user's computer and relays to the application server. A Bootstrap servlet instructing the application where to make its main request and what parameters should be passed. The client then makes the main request. A load balancer is included within the application servers. A load balancer then chooses which server is to be used. This can be done on a predetermined basis. For example, the load balancer may pass requests to the servers alternatively or randomly. In addition if a server crashes, the load balancer will divert all incoming requests to the remaining available servers. The application also makes use of a user side load balancer, which avoids the problems commonly associated with balancing HTTP on the server side.

The chosen server responds to the Java application with processing instructions and data. The web server used in the present invention comprises an apache web server.

The application receives the instructions and data and enriches the original message data. This is done by parsing the data. A parser is a program which processes a stream of tokens according to grammatical rules. The parser is often fed by a tokenizer which assembles a stream of characters (e.g. from a document) into tokens. Many parsers have an inbuilt tokenizer allowing them to process character streams directly.

Once this operation is complete the enriched data is returned to be passed onto an ISP or, if web mail is used to the web monitor.

The invention further comprises a plurality of database servers which communicate to the application servers through Java database connectivity. A database server is a computer system that processes database queries. This database is replicated onto a second database.

As stated above the present invention is capable of application with both ISP email services and webmail services. There are differences between the implementation of the invention when considering the possible forms of mail transfer. Descriptions of both types of activity by the application are set out below.

Email users, using an ISP, will download the application onto their computer. The process of inserting an advert into an Email is controlled by communication between the application and a server, termed a mail server.

When the user sends or receives electronic communication the application detects the communication and identities itself to the mail server and requests instructions. The server responds with instruction as described above. The application then transmits details to the server as instructed by the server. This may include mail headers, previously gathered contacts and the like. The mail server responds with branding instructions and content of the information to be inserted. The server may also instruct the application to collect details of new contacts (such as new email addresses). The application then modifies the transmission in accordance with the instructions from the server and forwards the transmission on to its originally destination. This will usually be the ISP.

The system is slightly different for webmail users. In this case the application passes each web request and response to a local webmail registry to ascertain which requests or responses are webmail sends or receives.

An optimised look-up algorithm has been designed for the webmail registry to use that will allow non-webmail requests and responses to pass through the application almost instantaneously.

The webmail registry runs locally for optimal performance, however it is refreshed regularly from the mail server to allow webmail services to be added and modified centrally and updated transparently.

If the registry recognises a webmail request or response then it provides a processor module to the application for further processing of the request or response. The Processor module comprises facilities for converting the webmail request or response into a canonical message format, obtaining details of the specific capabilities of the webmail service to the mail server and converting a canonical message back into the relevant webmail request or response.

The canonical formatted document is passed to the mail server, which acts upon the message using the same rules for standard SMTP/POP mail.

For incoming webmail, once the processing decisions have been made, the server sends instructions and the information to be embedded to the application which allows the application to process the instructions accordingly.

The process for outgoing mail is dependent upon the capabilities of the webmail service.

After the general processing decisions have been made the information is then embedded into the webmail. If the webmail service offers sufficient capabilities to fulfil the processing requirements by altering the message body, then instructions and information to inserted into the message body are supplied to the application. The application responds to the instructions and alters the message body, before allowing the message to pass through the webmail service and on to its original destination. The individual webmail processor allows the request to be modified in such a way that it fulfils the applications processing requirements without adversely affecting the operation of the webmail service.

However, if the webmail service does not have sufficient capabilities a different approach is required. In this scenario a docket id is generated. The docket id is created using a technique that makes it impossible for a third party to generate a fake docket id. The original recipients of the email and the subject of the email are stored in the storing database, along with a unique application id, using the docket id as a key. The application is then sent instructions to remove the existing subject matter and recipient addresses and to readdress the email to the mail server using the docket id as the mail subject. The application responds to the instructions and alters the message accordingly, before allowing the message to pass through the webmail service. The individual webmail processor allows the request to be modified in such a way that it fulfils the application processing requirements without affecting the operation of the webmail service.

After the mail leaves the webmail servers it will arrive at the mail server that is running a server-side version of the application. The mail server extracts the docket id form the subject line and researches the original subject, recipients and the local application id from the database. The original mail headers are reinstated in the mail, which is then processed by the server-side application exactly as if it was running on the local computer. The email then continues on to its original address.

Fake docket ids are handled with in accordance with current business rules.

It is to be understood that the above described specific embodiments are described by way of an example only and that many modifications and variations are permitted within the scope of the invention.

1. A method of embedding additional information into an electronic communication transmitted via a network from a sending party to a receiving party comprising the steps of:
(i) intercepting the electronic network communication sent by the sending party addressed to the receiving party;
(ii) extracting and sending information relating to the network communication to a remote server;
(iii) modifying the network communication to embed the additional information in the network communication according instructions and information provided by the remote server in response to the information sent to the remote server; and
(iv) transmitting the modified network communication to the receiving party.

2. A method according to claim 1, wherein the additional information comprise one or more textual content, graphical content, links to other information, audio content and visual content.

3. A method according to claim 1, wherein the remote server is located on the same physical device on which the communications are intercepted.

4. A method according to claim 1, wherein the remote server generates the instructions and information for modifying the communication by employing an algorithm running on the remote server that combines the information extracted from the communication with one or more rules, other information, historical data or a combination of these.

5. A method according to claim 4, wherein the algorithm applies the same generic rules to all communications.

6. A method according to claim 4, wherein different rules are applied to different individual senders and/or recipients or groups of senders and/or recipients.

7. A method according to claim 1, wherein the communication is intercepted and modified at a device that is physically remote from sending party and receiving party.

8. A method according to claim 1, wherein the additional information is advertising material.

9. A method according to claim 1, wherein the additional information is reference information.

10. A method according to claim 1, wherein the intercepted communication is an email.

11. A method according to claim 1, wherein the content of the additional information embedded in the communication is determined based at least in part on historical data held about the sending and receiving parties.

12. A method according to claim 1, wherein the content of the additional information embedded in the communication is determined at least in part on preference data held for one or both of the sending party and receiving party.

13. A method according to claim 12, wherein the preference data comprises the communication format capabilities of the receiver party.

14. A method according to claim 1, wherein the interception of the communications can be controlled remotely.

15. A method according to claim 1, wherein the additional information comprises a reference to further information content it is intended be displayed within the message.

16. A method according to claim 1, comprising remotely detecting the identify of the ISP hosting a receiving party or a sending party.

17. A method according to claim 1, wherein the communication is addressed to multiple receiving parties, the method further comprising replicating the communication to create a separate instance of the communication for each of the receiving parties.

18. A communication system comprising an electronic communication processing center engine loadable onto a computer wherein the electronic communication processing engine is capable of intercepting an electronic communication sent over a network from a sending party to a receiving party, sending information about the communication to a remote server and modifying the communication based on a reply from the remote server to embed additional information in it.

19. A system operable in accordance with the method of claim 1.

20. A system according to claim 18, wherein the electronic communication processing engine forms part of the transmission path for the communication.

21. A computer program which is executable on a computer or a distributed network of computers to cause the computer or network of computers to operate in accordance with the method of claim 1.

22. A computer program according to claim 21, stored on a computer readable media.
